(19) United States
(12) Patent Application Publication
(10) Pub. No.: US 2008/0227441 A1
(43) Pub. Date: Sep. 18, 2008

(54) SYSTEMS AND METHODS FOR A UNIVERSAL BASE STATION

(75) Inventors: Michael J. Hermel, Waseca, MN (US); Steven B. Stuart, Eden Prairie, MN (US)

Correspondence Address: FOGG & POWERS LLC, 10 SOUTH FIFTH STREET, SUITE 1000, MINNEAPOLIS, MN, 55402, US

(73) Assignee: ADC TELECOMMUNICATIONS, INC., Eden Prairie, MN (US)

(21) Appl. No.: 11/684,924

(22) Filed: Mar. 12, 2007

(51) Int. Cl. H04Q 7/20; H04B 1/38

(52) U.S. Cl. 455/422.1; 455/561

(57) ABSTRACT

Systems and methods for a universal base station are provided. In one embodiment, a base station for processing a plurality of communications channels for up to a plurality of network operators comprises a transceiver module communicatively coupled to up to a plurality of network operators, the transceiver module configured to process a plurality of upstream communication channels and a plurality of downstream communication channels based on one or more wireless communication modulation protocols, each of the upstream and downstream communication channels associated with one of the network operators. The transceiver module is configured to output a combined downstream RF signal based on the downstream communication channels. The transceiver module is configured to output a plurality of upstream data packets based on the upstream communication channels, each upstream data packet of the plurality of upstream data packets associated with one of the up to a plurality of network operators.

### BACKGROUND

In wireless communication networks of the art today, such as cellular networks, network operators typically own and operate their own base station equipment and therefore must front the cost of installing such equipment. In urban areas, costs for installing new base stations are readily recovered because of increased revenues generated by wireless network subscriber's use of increased network capacity. To provide wireless communications for subscribers in rural or isolated areas, however, network operators have less economic incentive to invest in the installation of base station equipment because the prospects for growth in the installed subscriber base are significantly more limited when compares to urban areas.

For the reasons stated above and for other reasons stated below which will become apparent to those skilled in the art upon reading and understanding the present specification, there is a need in the art for improved systems and methods for reduced cost base station solutions for wireless communication networks operators serving rural or isolated areas.

### SUMMARY

The Embodiments of the present invention provide methods and systems for reduced cost base station solutions, and will be understood by reading and studying the following specification.

In one embodiment, a base station for processing a plurality of communications channels for up to a plurality of network operators is provided. The base station comprises a transceiver module communicatively coupled to up to a plurality of network operators, the transceiver module configured to process a plurality of upstream communication channels and a plurality of downstream communication channels based on one or more wireless communication modulation protocols, each of the upstream and downstream communication channels associated with one of the network operators. The transceiver module is configured to output a combined downstream RF signal based on the downstream communication channels. The transceiver module is configured to output a plurality of upstream data packets based on the upstream communication channels, each upstream data packet of the plurality of upstream data packets associated with one of the up to a plurality of network operators.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a communication network of one embodiment of the present invention;

FIG. 2 is a diagram illustrating a universal base station of one embodiment of the present invention;

FIG. 3 is a diagram illustrating a universal base station of one embodiment of the present invention; and

FIG. 4 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings, which form a part hereof, and in which is shown by way of illustrating specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention enable multiple telecommunications network operators to implement their networks using shared hardware platforms thus reducing the costs of capital investments and operations and maintenance costs on a per-operator basis. Embodiments of the present invention further enable the ability to divide, assign, configure, manage and monitor resources of a shared hardware platform using software.

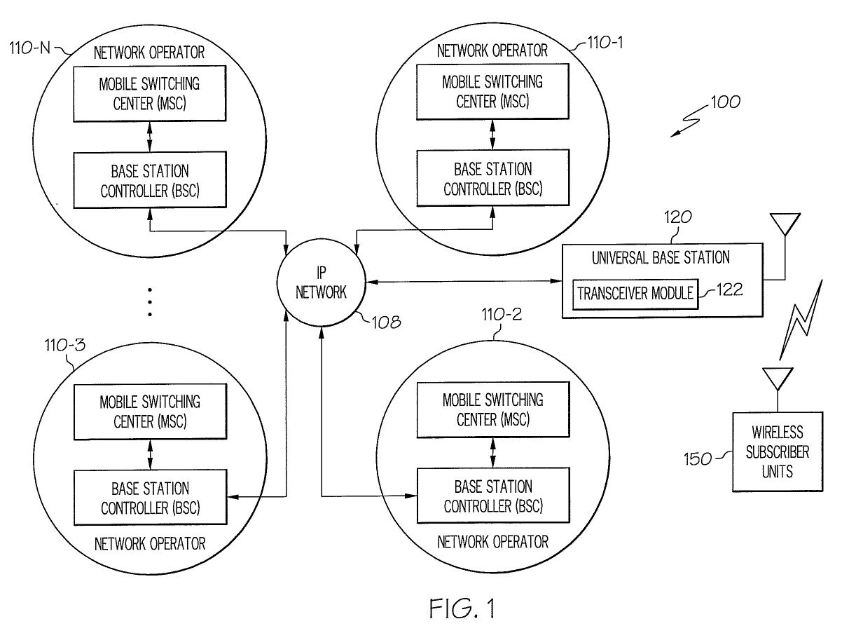

FIG. 1 is a block diagram of a bidirectional communication network 100 of one embodiment of the present invention. Communication network 100 comprises one or more network operators (shown as network operators 110-1 to 110-N) that supply wireless communications services to their subscribers (shown as wireless subscriber units 150). The wireless communications services include services such as, but not limited to, voice telecommunications, video telecommunications, access to the Internet, access to the public switched telephone network (PSTN), broadband data communications and other services benefiting from high speed and/or high bandwidth data transfers. Network operators 110-1 to 110-N are each coupled to an internet protocol (IP) network 108. Communication network 100 also comprises a universal base station 120 coupled to IP network 108. IP network 108 utilizes an IP addressing scheme to transport data packets between network operators 110-1 to 110-N and universal base station 120, such as but not limited to IP version 4 (IPv4) or IP version 6 (IPv6), for example. Universal base station 120 is also communicatively coupled to the one or more wireless subscriber units 150. In operation, universal base station 120 communicates via wireless radio frequency (RF) signals with wireless subscriber units 150. Universal base station 120 also communicate voice and data signals associated with those wireless RF signals with network operators 110-1 to 110-N as data packets over IP network 108. Accordingly, IP network 108 is a bidirectional network and as shown includes equipment for realizing forward links (e.g., transmissions on forward communication channels from network operators 110-1 to 110-N to wireless subscriber units 150) and reverse links (e.g. transmissions on reverse communication channels from mobile wireless subscriber units 150) to network operators 110-1 to 110-N).

In one embodiment, universal base station 120 includes a transceiver module 122 that handles multiple types of wireless communication modulation protocols, based on the particular communications needs specified by the particular network operators 110-1 to 110-N coupled to the universal base station 120. These modulation protocols include, but are not limited to, Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), Orthogonal Frequency Division Multiplexing (OFDM), or any other appropriate modulation protocol. A modulation protocol is also commonly referred to as an air interface standard, a modulation standard, an air interface protocol, or an air interface modulation protocol. For each of network operators 110-1 to 110-N, transceiver module 122 performs modulation and demodulation for forward and reverse communications channels using one of the wireless communication modulation protocols for a particular communications channel. For example, in one embodiment one of the network operators (Such as network operator 110-1, for example) may communicate data with one or more of subscriber units 150 using a GSM protocol communication channel while another network operator (Such as network operator 110-1, for example) may communicate data with one or more of subscriber units 150 based on a CDMA protocol communication channel.

In one embodiment, one or more of network operators 110-1 to 110-N each include a mobile switching center (MSC) 112 and a base station controller (BSC) 114. For a particular network operator (network operator 110-1, for example), the BSC 114 controls the network operator's data communication flow through universal base station 120 while MSC 112 operates to control the data communication flow through the BSC 114. In one embodiment, an MSC 112 is coupled to, and controls, multiple BSCs belonging to a network operator. In that case, the MSC 112 identifies a base station (such as universal base station 120, for example) having the shortest distance to a wireless subscriber unit 150 and switches data communications for that wireless subscriber unit 150 to that closest identified base station.

Embodiments of the present invention allow network operators 110-1 to 110-N to share universal base station 120 resources by enabling each of network operators 110-1 to 110-N to manage an assigned set of these resources as if each were operating their own dedicated base station.

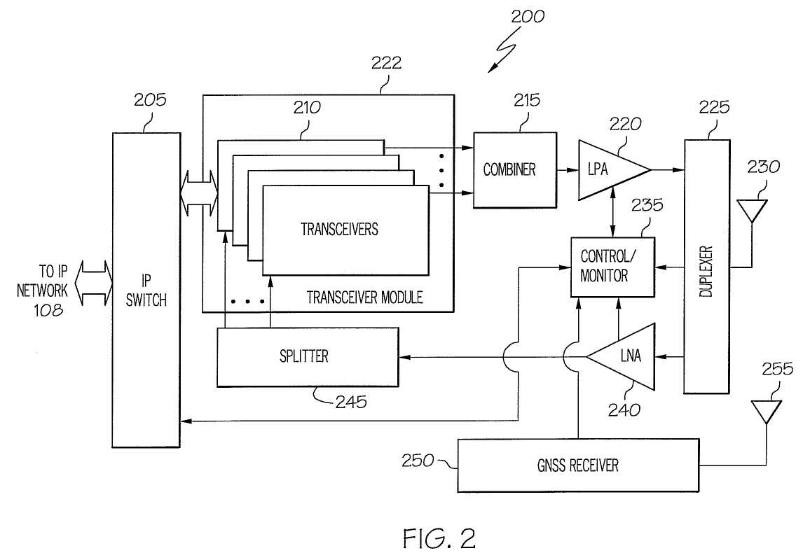

FIG. 2 is a block diagram of a universal base station 200 of one embodiment of the present invention, such as universal base station 120. Universal base station 200 is one example of a universal base station 120 have a transceiver module 122 implemented using a channelized hardware approach. That is, universal base station 200 comprises a transceiver module 222 having a plurality of radio frequency (RF) transceivers 210, each performing modulation, demodulation, and other signal processing function for a single communication channel. Each RF transceiver 210 includes the functionality required to modulate an RF carrier using data packets received from one of network operators 110-1 to 110-N and output a modulated RF signal that carries voice and/or data information from those data packets. Radio frequency (RF) transceivers 210 also each include the functionality required to demodulate RF carrier signals received from one or more of wireless subscriber units 150 and output data packets carrying voice and/or data information from wireless subscriber units 150 for transmission on IP network 108. Each transceiver thus processes a single RF channel for forward and reverse link communication channels.

For example, in one embodiment, universal base station 200 includes four RF transceivers 210, each a GSM transceiver that operates on a different RF carrier frequency that the others. The four GSM transceivers can be assigned to up to four difference network operators, each GSM transceiver processing the communications traffic for one GSM channel for one of the network operators. In another embodiment, RF transceivers 210 include two GSM transceivers, an EDGE transceiver, and a CDMA transceiver. One GSM transceiver and the EDGE transceiver handle one GSM communication channel and one EDGE communication channel, respectively, for one network operator (Such as network operator 110-1, for example). The second GSM transceiver handles a GSM communication channel for second network operator (Such as network operator 110-2, for example), and the CDMA transceiver handles a CDMA communication channel for a third network operator (Such as network operator 110-3, for example). In one implementation of universal base station 200, the RF transceivers 210 are each modularized base-station devices, such as, but not limited to, the nanoBTS manufactured by ip.access Ltd.

Each of the RF transceivers 210 represent a resource of universal base station 200 that is allocated to one of the network operators 110-1 to 110-N and dedicated to the processing of communication channel via an RF channel associated with that one network operator. To facilitate communications between each of network operators 110-1 to 110-N and their allocated RF transceiver, each of the RF transceivers 210 is assigned a unique network address for network 108.

In one embodiment, each RF transceiver 210 is assigned a unique IP address that is within a range of IP addresses used by the respective network operator it is allocated to. For a given communication channel, a network operator transports network traffic to and from their assigned RF transceiver based on the IP address assigned to that RF transceiver. Additionally, the network operator can send configuration and control information to the assigned RF transceiver, as well as receives status and alarm messages, based on the assigned IP address. Separation of RF transceiver operation by IP address assures that each network operator can control and monitor only those resources universal base station 200 to which they are assigned.

In the embodiment shown in FIG. 2, universal base station 200 also comprises an IP switch 205 coupled to IP network 108 and RF transceivers 210. In operation, IP switch 205 routes data packets between IP network 108 and the RF transceivers 210 based on destination addresses of the data packets. For example, when IP switch 205 receives a data packet from a first of RF transceivers 210 addressed to one of the network operators 110-1 to 110-N, IP switch 205 routes that data packet to IP network 108. Similarly, when IP switch 205 receives a data packet from IP network 108 addressed to a particular one of the RF transceivers 210, IP switch routes that data packet to that particular RF transceiver.

In the embodiment shown in FIG. 2, universal base station 200 further comprises a combiner 215, a linearized power amplifier (LPA) 220, a duplexer 225, an RF antenna 230, a station supervisor 235, a low noise amplifier (LNA) and a splitter 245. Combiner 215 is coupled to RF transceivers 210. In forward link operation, combiner 215 receives the modulated RF signal outputs from each of the RF transceivers 210 and combines the modulated RF signal outputs into a single combined RF signal to LPA 220. LPA 220 amplifies the power of the combined RF signal for wireless transmission and outputs an amplified combined RF signal to duplexer 225 to transmit the amplified combined RF signal over RF antenna 230. In reverse link operation, RF antenna 230 receives RF signals from one or more of the wireless subscriber units 150 and provides the RF signals to duplexer 225. Duplexer 225 routes the received RF signals to LNA 240, which amplifies the RF signals and outputs the amplified RF signals to splitter 245. Splitter 245 provides the RF signals to each of RF transceivers 210. RF transceivers 210 each demodulate an RF carrier from the RF signals to produce data packets that represent voice and/or data communications from wireless subscriber units 150. In one embodiment, RF transceivers 210 each band pass filter the RF signals received from splitter 245 based on the particular RF frequency band demodulated by each of the RF transceivers 210.

As discussed above, any one network operator may be allocated the use of one or more of the RF transceivers 210. When allocated a transceiver on universal base station 200, a network operator can control those signal processing parameters typically available to network operators by sending messages to their assigned transceiver. As would be appreciated by one of ordinary skill in the art upon reading this specification, these signal processing parameters include, but are not limited to the channel carrier frequency, the modulation protocol for a channel (for example, GSM, GPRS, and EDGE), voice encoder (VOCODER) setting, and power levels of the transceiver's output.

The allocation of RF transceivers 210 to a particular network operator is controlled via software, for example, by assigning an IP address to the RF transceivers within the range of the network operator's IP addresses. In one embodiment, the IP addresses for each transceiver is manually established during the initial set up of universal base station 200. In other embodiments, the IP addresses can be reconfigured remotely.

As illustrated in FIG. 2, universal base station 200 also includes a station supervisor 235. Station supervisor 235 is coupled to IP switch 205 and is also assigned an IP address to enable communication with station supervisor 235 via IP network 108. In one embodiment, station supervisor 235 monitors the operating condition of universal base station 200. For example, in one embodiment, station supervisor 235 monitors the status of universal base station 200 parameters such as, but not limited to RF signal transmission and reception power levels, the voltage signal wave ratio (VSWR) of antenna 230, and the health and operating status of LPA 225, duplexer 225, and LNA 240. In alternate embodiments, station supervisor 235 can also monitor the status of auxiliary equipment that supports operation of RF transceivers 210 such as, but not limited to, power supplies, batteries, ambient cabinet temperatures, and cabinet alarm conditions (for example, a cabinet door open alarm), and perform other diagnostic functions. In one embodiment, station supervisor 235 also includes control functionality, such as but not limited to the ability to turn on or off LPA 225, the ability to disable individual RF channels by turning off one or more of RF transceivers 210, and the ability to re-allocate the resources of universal base station 200 by changing IP address assignments for RF transceivers 210.

In alternate embodiments, the various functions of station supervisor 235 can be made accessible to one or more entities. For example, in one implementation, functions of station supervisor 235 can be made accessible to a base station operator that is a neutral host who is not one of the network operators 110-1 to 110-N (for example, a neutral host that owns universal base station 200 or is otherwise responsible for managing universal base station 200). In another implementation, functions of station supervisor 235 can be made accessible to one of the network operators 110-1 to 110-N (for example, if one of the network operators also owns universal base station 200 and further serves as a host for other network operators). In still another implementation, functions of station supervisor 235 can be made accessible to more than one of the network operators 110-1 to 110-N.

Network operators 110-1 to 110-N can also be selectively allowed to access a subset of the functions of station supervisor 235. For example, all network operators may be allowed to monitor for certain alarm conditions, (such as a LPA 225 failure, for example) but only the base station operator may be allowed to monitor real-time transmitter power levels or turn the LPA 225 on or off. In other embodiments, if a base station operator allows, network operators can also monitor parameters such as, but not limited to the antenna VSWR and the health of the LNA.

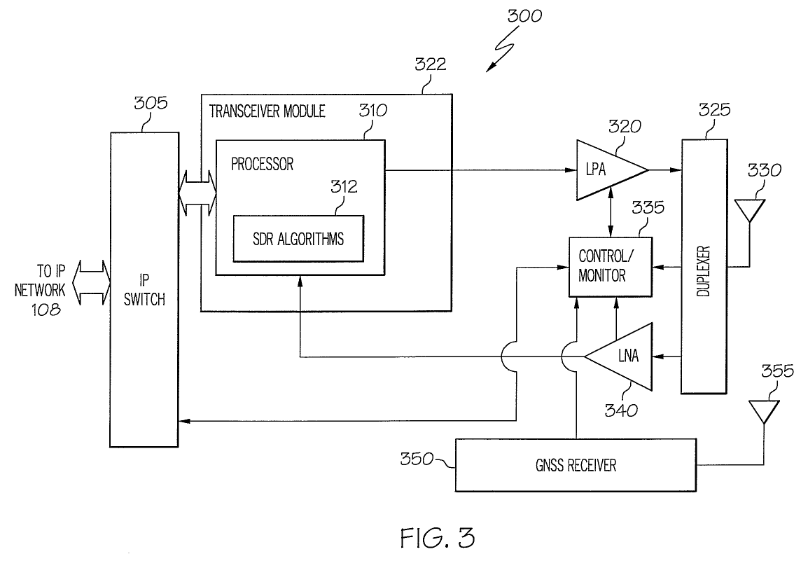

FIG. 3 is a block diagram of a universal base station 300 of one embodiment of the present invention, such as universal base station 120. Universal base station 300 is one example of a universal base station 120 have a transceiver module 122 implemented using a software defined radio (SDR). That is, as opposed to utilizing a plurality of channilized RF transceivers, universal base station 300 comprises a transceiver module 322 that includes a software defined radio. That is, transceiver module 322 includes a processor 310 executing one or more SDR algorithms 312. Signal processing (including modulation and demodulation) of the RF signals for individual communication channels is accomplished through SDR algorithms 312 by the digital manipulation of a broadband data stream as logical RF channels. A broadband RF signal is then generated by processor 310 that represents the combined downstream output of the logical RF channels.

For example, in one embodiment, a processor 310 receives a broadband data stream from IP switch 108 that includes voice and/or data communication channels from each of network operators 110-1 to 110-N. In one such an embodiment, SDR algorithms 312 utilize digital filtering to extract individual communication channels into logical RF channels, and then process the logical RF channels based on parameters provided by network operators 110-1 to 110-N. As described with respect to FIG. 2, each network operators 110-1 to 110-N can control those signal processing parameters for their communication channels typically available to network operators by sending control messages to the IP address associated with their allocated base station resource (for example, an IP address associated with a logical RF channel). As would be appreciated by one of ordinary skill in the art upon reading this specification, these signal processing parameters include, but are not limited to the channel carrier frequency, modulation schemes (for example, GSM, GPRS, and EDGE), VOCODER settings, and power levels of the transceiver's output. SDR algorithms 312, in software, perform each of those functions described above with respect to the RF transceivers 210, such as, but not limited to the modulation and demodulation of forward and reverse channel data streams using one or more of the air interface standard protocols described above.

In one embodiment, processor 310 includes a single network interface 312 that accommodates multiple IP addresses and includes the functionality required to facilitate communications between the network operators 110-1 to 110-N and processor 310. In one such embodiment, SDR algorithms 312 associate a network operator with an allocated logical RF channel based on IP addresses. In other embodiments, the processor 310 is assigned a single IP address on IP network 108, and other means are used to associate a network operator with their allocated logical RF channel.

With respect to choosing between a universal base station implemented using a channelized hardware approach, such as universal base station 200, versus a universal base station implemented using a software defined radio, such as universal base station 300, channelized hardware may prove more economical for realizing a system having a relatively fewer number of distinct RF channels, while a systems implementing a broadband software approach could be selected for a greater number of channels. As would be appreciated by one of ordinary skill in the art upon reading this specification, the crossover point is a matter of economic consideration.

Returning to FIG. 2, in one embodiment, universal base station 200 includes a global navigation satellite system (GNSS) receiver 250, such as, but not limited to a Global Positioning System (GPS) receiver. As would be appreciated by one of ordinary skill in the art upon reading this specification, the ability of a transceiver to maintain frequency stability is largely determined by the accuracy of oscillators. In one embodiment GNSS receiver 250 receives a signal from a GNSS satellite (not shown) that provides a frequency or other timing reference to assist locking RF transceivers 210 onto their assigned frequencies. In one embodiment, GNSS receiver 250 provides station supervisor 235 with the coordinate location of universal base station 200 for auto provisioning purposes. In other words, once station supervisor 235 receives the coordinates of universal base station 200, it can then request configuration information via IP network 108 based on the coordinates. In one embodiment, such configuration information may be provided by one of network operators 110-1 to 110-N. In other embodiments, signals from GNSS receiver 250 may be used for coordinating events between universal base station 200 and other base stations (not shown) such as utilizing timing marks for performing synchronous hand offs of wireless subscriber units 150. FIG. 300 also illustrates universal base station 3 having a GNSS receiver 350 coupled to station supervisor 335. For the embodiment shown in FIG. 3, GNSS receiver 350 provides the same functionality as described above with respect to GNSS receiver 250 in FIG. 2.

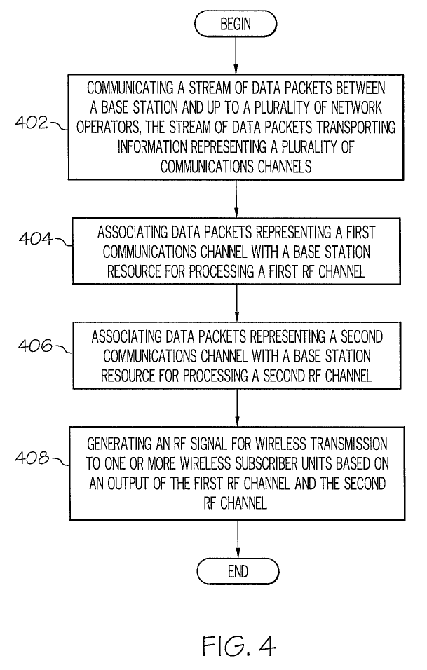

FIG. 4 is a flow chart illustrating a method of one embodiment of the present invention. In some embodiments, the method of FIG. 4 is implemented using the universal base station systems described with respect to FIGS. 1, 2 and 3. In other embodiments, other base station system embodiments are used. The method begins at 402 with communicating a stream of data packets between a base station and up to a plurality of network operators, the stream of data packets transporting information representing a plurality of communications channels. As described above, the communication channels carry voice and/or data between the network operators and wireless subscriber units.

Embodiments of the present invention allow various network operators to share the signal processing resources available from a base station by enabling each of network operators manage an assigned set of these resources as if each were operating their own dedicated base station. This is accomplished by associating each network operator with signal processing resources provided by the base station. Accordingly, the method proceeds to 404 with associating data packets representing a first communications channel with a base station resource for processing a first RF channel and to 406 with associating data packets representing a second communications channel with a base station resource for processing a second RF channel. In one embodiment, a base station resource for processing an RF channel includes a single channel RF transceiver, such as described above with respect to RF transceivers 210. In another embodiment, a base station resource comprises a logical RF channel processes by a software defined radio as described with respect to FIG. 3. In both cases, the base station resource includes the functionality required to performing modulation, demodulation, and other signal processing function for a upstream and downstream communication channels. Modulation and demodulation is performed based on one or more wireless communication modulation protocols, such as, but not limited to Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), Orthogonal Frequency Division Multiplexing (OFDM), or any other appropriate modulation protocol.

In one embodiment, the base station resources are assigned network addresses in order to associate data packets representing a given communications channel with the base station resource allocated for that communication channel. In that case, a network operator addresses downstream data packets to a specific base station resource by specifying the network address of the desired base station resource in the downstream data packets. Similarly, upstream data packets produced by the base station are routed from the base station to specific network operators by specifying the network address of the network operators in the upstream data packets. In one embodiment, reconfiguring the allocation of a specific base station resource to a network operator is accomplished by changing the network address of the base station resource. That is, a resource can be re-assigned to a new network operator by assigning the base station resource a net network address that is associated with the new network operator. The reconfiguration can be performed through software either locally at the base station, or remotely by sending reconfiguration instructions either to the resource, or to a base station's station supervisor.

The method proceeds to 408 with generating an RF signal for wireless transmission to one or more wireless subscriber units based on an output of the first RF channel and the second RF channel. In one embodiment, a plurality of RF signals are produced by the base station resources, one for each downstream communication channel, and the plurality of RF signals are combined into a single broadband RF signal that is wirelessly transmitted to the wireless subscriber units.

In one embodiment, a network operator can adjust one or more signal processing parameters for their assigned base station resource though a message sent to that resource. Adjustable signal processing parameters can include, but are not limited to carrier frequency, the wireless communication modulation protocol, a VOCODER setting, and RF signal power levels. In another embodiment, a base station operator can monitor base station system operating conditions such as, but not limited to RF signal transmission power levels, an RF signal reception power levels, voltage signal wave ratio, linearized power amplifier status, low noise amplifier status, duplexer status, power supply status, battery power status, ambient environment conditions, and cabinet alarms. In one embodiment, the station supervisor monitors the base station system operating conditions and communicates status information to the base station operator. In another embodiment, the base station operator can also adjust base station system operating parameters such as, but not limited to, whether a particular base station resource is enabled or disabled, switching power to a linearized power amplifier, and revising a network address associated with a base station resource. In one embodiment, the base station operator can access the station supervisor via a network address assigned to the station supervisor.

Although embodiments described in this specification discuss the present invention in terms of a network interfaces that utilizes IP standards, one of ordinary skill in the art would appreciate that embodiments of the present invention are not so limited, but also apply to other network interface standards. In addition, embodiments wherein network operators communicate with a universal base station using communication links such as, but not limited to, wired, optical, wireless, or other communication links are contemplated as within the scope of embodiments of the present invention. For example, in one embodiment a universal base station wirelessly communicates voice and/or data information with one or more network operators based on wireless standards such as IEEE 801.11 (WiFi), IEEE 802.16 (WIMAX), or IEEE 802.20 (MBWA).

Several means are available to implement the systems and methods of the current invention as discussed in this specification. In addition to any means discussed above, these means include, but are not limited to, digital computer systems, microprocessors, programmable controllers and field programmable gate arrays. Therefore other embodiments of the present invention are program instructions resident on computer readable media which when implemented by such controllers, enable the controllers to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A base station for processing a plurality of communications channels for up to a plurality of network operators, the base station comprising:
a transceiver module communicatively coupled to up to a plurality of network operators, the transceiver module configured to process a plurality of upstream communication channels and a plurality of downstream communication channels based on one or more wireless communication modulation protocols, each of the upstream and downstream communication channels associated with one of the up to a plurality of network operators;
wherein the transceiver module is configured to output a combined downstream RF signal based on the plurality of downstream communication channels; and
wherein the transceiver module is configured to output a plurality of upstream data packets based on the plurality of upstream communication channels, each upstream data packet of the plurality of upstream data packets associated with one of the up to a plurality of network operators.

2. The base station of claim 1, wherein the transceiver module is configured to process the plurality of upstream RF channels and the plurality of downstream RF channels using on one or more of Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

3. The base station of claim 1, wherein the transceiver module comprises a plurality of single channel transceiver units, each of the plurality of single channel transceiver units associated with processing a communication channel for one of the up to a plurality of network operators.

4. The base station of claim 3, wherein a first single transceiver unit of the plurality of single transceiver units is configured to modulate a first RF carrier based on data packets received from a first network operator of the up to plurality of network operators; and
wherein a second single transceiver units of the plurality of single transceiver unit is configured to modulate a second RF carrier based on data packets received from a second network operator of the up to plurality of network operators.

5. The base station of claim 3, wherein a first single transceiver unit of the plurality of single transceiver units is configured to modulate a first RF carrier using a first wireless modulation protocol based on data packets received from a first network operator of the up to plurality of network operators; and
wherein a second single transceiver unit of the plurality of single transceiver units is configured to modulate a second RF carrier using a second wireless modulation protocol based on data packets received from the first network operator.

6. The base station of claim 1, wherein the transceiver module comprises a processor configured to implement a software defined radio.

7. The base station of claim 6, wherein the software defined radio receives a downstream broadband signal representing the plurality of downstream communication channels; and
wherein the software defined radio generates an upstream broadband signal representing the plurality of upstream communication channels.

8. The base station of claim 6, wherein the software defined radio includes one or more algorithms to process a plurality of upstream logical RF channels based on one or more wireless communication modulation protocols, the upstream logical RF channels representing the upstream communication channels; and
wherein the software defined radio includes one or more algorithms to process a plurality of downstream logical RF channels based on one or more wireless communication modulation protocols, the downstream logical RF channels representing the downstream communication channels.

9. The base station of claim 1, wherein the transceiver module is configured to associate the upstream and downstream communication channels with the up to a plurality of network operators based on network addresses base on network addresses.

10. The base station of claim 1, wherein the transceiver module is configured to adjust one or more signal processing parameters for a first RF channel based on instructions received from a first network operator associated with the first RF channel.

11. The base station of claim 10, wherein the one or more signal processing parameters include at least one of a carrier frequency, a wireless communication modulation protocol, a VOCODER setting, and an RF signal power level.

12. The base station of claim 1, further comprising:
a station supervisor configured to monitor base station system operating conditions.

13. The base station of claim 12, wherein the base station system operating conditions include a status of at least one of an RF signal transmission power level, an RF signal reception power level, a voltage signal wave ratio, status of a linearized power amplifier, status of a low noise amplifier, status of a duplexer, status of a power supply, status of a battery, ambient environment conditions, and cabinet alarms.

14. The base station of claim 12, the station supervisor further configured to adjust one or more base station system operating parameters.

15. The base station of claim 12, wherein the one or more base station system operating parameters include at least one of power to a linearized power amplifier, base station resource enabling, and base station resource network addresses.

16. The base station of claim 12, wherein the station supervisor is associated with a network address.

17. The base station of claim 12, wherein the one or more of the up to a plurality of network operators communicate with the station supervisor based on the station supervisor network address.

18. The base station of claim 12, wherein a base station operator communicates with the station supervisor based on the station supervisor network address.

19. The base station of claim 12, further comprising:
a global navigation satellite system (GNSS) receiver coupled to the station supervisor.

20. The base station of claim 19, wherein the global navigation satellite system (GNSS) receiver is configured to provide the station supervisor with at least one of a coordinate location, a frequency, and a timing reference.

21. A method for wireless communication, the method comprising:
communicating a stream of data packets between a base station and up to a plurality of network operators, the stream of data packets transporting information representing a plurality of communications channels;
associating data packets representing a first communications channel of the plurality of communications channels with a base station resource for processing a first RF channel;
associating data packets representing a second communications channel of the plurality of communications channels with a base station resource for processing a second RF channel; and
generating an RF signal for wireless transmission to one or more wireless subscriber units based on an output of the first RF channel and the second RF channel

22. The method of claim 21, further comprising:
reconfiguring an allocation of one or more base station resources to at least one of the up to a plurality of network operators.

23. The method of claim 22, wherein reconfiguring the allocation of one or more base station resources further comprises associating the one or more base station resources with the at least one of the up to a plurality of network operators via software.

24. The method of claim 21, wherein
associating data packets representing the first communications channel of the plurality of communications channels with a base station resource for processing the first RF channel further comprises associating data packets representing the first communications channel with a first single channel transceiver; and
associating data packets representing the second communications channel of the plurality of communications channels with a base station resource for processing the second RF channel further comprises associating data packets representing the second communications channel with a second single channel transceiver.

25. The method of claim 24, further comprising:
generating a combined RF signal based on a first RF signal generated by the first single channel transceiver and a second RF signal generated by the second single channel transceiver

26. The method of claim 21, wherein
associating data packets representing the first communications channel of the plurality of communications channels with a base station resource for processing the first RF channel further comprises associating data packets representing the first communications channel with a first logical RF channel of a software defined radio; and
associating data packets representing the second communications channel of the plurality of communications channels with a base station resource for processing the second RF channel further comprises associating data packets representing the second communications channel with a second logical RF channel of a software defined radio.

27. The method of claim 26, further comprising:
generating a combined RF signal based on an output of the first logical RF channel and the second logical RF channel.

28. The method of claim 21, further comprising:
associating data packets representing the first communications channel of the plurality of communications channels with the base station resource for processing the first RF channel based on a network address.

29. The method of claim 21, further comprising:
adjusting one or more signal processing parameters of the base station resource for processing the first RF channel based on data packets received from a first network operator associated with the first communication channel.

30. The method of claim 29, wherein adjusting one or more signal processing parameters comprises adjusting one or more of a carrier frequency, a wireless communication modulation protocol, a VOCODER setting, and an RF signal power level.

31. The method of claim 21, further comprising:
monitoring base station system operating conditions using a station supervisor; and
communicating the base station system operating conditions to a base station operator.

32. The method of claim 31, wherein monitoring base station system operating conditions comprises monitoring one or more of an RF signal transmission power level, an RF signal reception power level, a voltage signal wave ratio, a status of a linearized power amplifier, a status of a low noise amplifier, a status of a duplexer, a status of a power supply, a status of a battery, an ambient environment condition, and a cabinet alarm.

33. The method of claim 31, further comprising:
associating the base station supervisor with a network address.

34. The method of claim 31, further comprising:
adjusting one or more base station system operating parameters based on data packets received from the base station operator.

35. The method of claim 31, wherein adjusting one or more base station system operating parameters comprises at least one of switching power to a linearized power amplifier, disabling a base station resource, and revising a network address associated with a base station resource.

36. The method of claim 21, further comprising:
processing the data packets representing the first communications channel and the data packets representing the second communications channel based on at least one wireless communication protocol.

37. A base station for processing a plurality of communications channels for up to a plurality of network operators, the base station comprising:
means for communicating with up to a plurality of network operators;
means for processing a plurality of downstream communication channels based on one or more wireless communication modulation protocols, each of the downstream communication channels associated with one of the up to a plurality of network operators, the means for processing a plurality of downstream communication channels responsive to the means for communicating with up to a plurality of network operators;
means for allocating signal processing resources of the means for processing a plurality of downstream communication channels to a first network operator of the up to a plurality of network operators, the means for processing a plurality of downstream communication channels further responsive to the means for allocating signal processing resources of the means for processing a plurality of downstream communication channels; and
means for generating a downstream RF signal, the means for generating a downstream RF signal responsive to the means for processing a plurality of downstream communication channels.

38. The base station of claim 37, further comprising:
means for communicating with up to a plurality of wireless subscriber units;
means for processing a plurality of upstream communication channels based on one or more wireless communication modulation protocols, each of the upstream communication channels associated with one of the up to a plurality of network operators, the means for processing a plurality of upstream communication channels responsive to the means for communicating with up to a plurality of network operators;
means for allocating signal processing resources of the means for processing a plurality of upstream communication channels to a first network operator of the up to a plurality of network operators, the means for processing a plurality of upstream communication channels further responsive to the means for allocating signal processing resources of the means for processing a plurality of upstream communication channels; and
means for generating a stream of data packets, the means for generating a stream of data packets responsive to the means for processing a plurality of upstream communication channels.
